(19) United States
(12) Patent Application Publication
(10) Pub. No.: US 2014/0365879 A1
(43) Pub. Date: Dec. 11, 2014

(54) USING ALIASES FOR DATE ENTRY

(71) Applicant: Microsoft Corporation, Redmond, WA (US)

(72) Inventors: Todd Lefor, Fargo, ND (US); Kevin Honeyman, Fargo, ND (US)

(21) Appl. No.: 13/912,546

(22) Filed: Jun. 7, 2013

(51) Int. Cl. G06F 17/24

(52) U.S. Cl. CPC G06F 17/24
USPC 715/261

(57) ABSTRACT

Date entries may be made using aliases in place of a specific dates. Instead of a user having to locate or determine a specific date for a date entry field, the alias that represents the date may be entered in the date entry field. The date for the alias is determined from a context of the date entry. For example, the context may include a determination as to what application is requesting the date, what entity is associated with the date entry, and the like. In a payroll date example, a next pay date “NPD” alias may change based on the employee. The data used to determine the date that is represented by the alias may be one or more data sets. The aliases may be associated with more than one application.

### BACKGROUND

A user enters dates into date fields of a computer application for a variety of different purposes. A common action is for a user to set a start date, an end date, and the like. For example, a calendar or timeline is displayed that allows a user to select one or more dates for the date entry.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Date entries may be made using aliases in place of specific dates. Instead of a user having to locate or determine a specific date for a date entry field, an alias that represents the date may be entered in the date entry field. For example, an alias such as “FYE” may be entered in a date field that is defined to represent the fiscal year end date for a company. The date for the alias is determined from a context of the date entry. For example, the context may include a determination as to what application is requesting the date, what entity is associated with the date entry, and the like. In a payroll date example, a next pay date “NPD” alias may change based on the employee. For example, some employees may be paid according to one payroll schedule whereas other employees may be paid on a different payroll schedule. The data set that is used to determine the date that is represented by the alias may be one or more data sets. Generally, the data set(s) that is used to determine the date is associated with a user or company relating to the date field. The aliases may be associated with more than one application. For example, the same alias may be used across different applications and may be interpreted the same or differently depending the on associated data.

### BRIEF DESCRIPTION OF THE DRAWINGS

FIG. 1 shows a system using an alias to specify a date without referring to a specific calendar date;

FIG. 2 shows displaying defined aliases and creating a new alias that represents a date;

FIG. 3 shows displaying a date in response to selecting an alias;

FIG. 4 shows using aliases in place of specific dates when specifying actions to perform;

FIG. 5 shows selecting an alias to enter into a date field;

FIG. 6 illustrates a process for using an alias that represents a date in a date field;

FIG. 7 illustrates a process for configuring a definition of an alias that represents a date;

FIG. 8 illustrates an exemplary online system for using aliases for date entry; and

FIGS. 9, 10A, 10B and 11 and the associated descriptions provide a discussion of a variety of operating environments in which embodiments of the invention may be practiced.

### DETAILED DESCRIPTION

Referring now to the drawings, in which like numerals represent like elements, various embodiment will be described elements, various embodiment will be described.

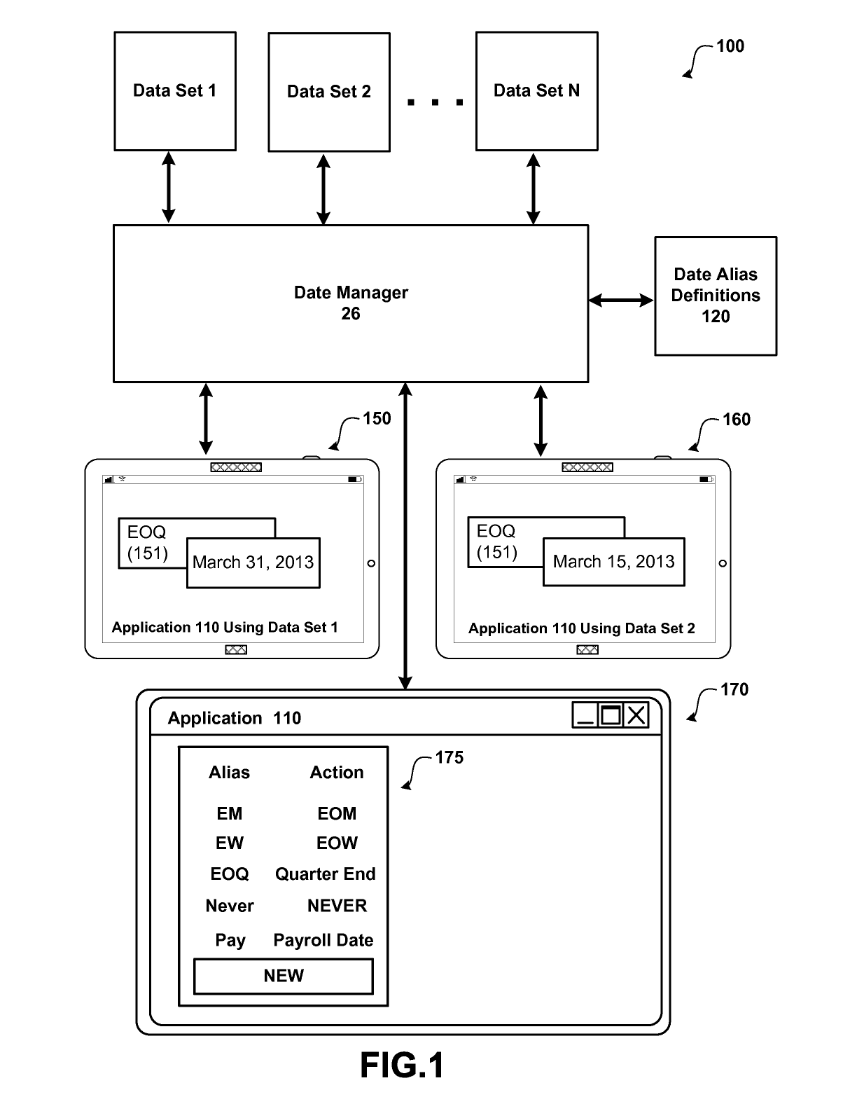

FIG. 1 shows a system using an alias to specify a date without referring to a specific calendar date.

As illustrated, system 100 includes application 110, date alias definitions 120, data sets 1-N, date manager 26, tablet computing device 150, tablet computing device 160, and computing device 170.

Date manager 26 is configured to use and define aliases for date entry. A defined alias represents a date without referring to a specific calendar date. Instead of a user having to locate or determine a specific date for a date entry field, a defined alias that represents the date may be entered in the date entry field. For example, tablet 150 and tablet 160 show the use of an “EOQ” alias 151 that has been defined to represent an end of quarter for a company. Different companies may have different dates that are associated with the same alias. In the current example, tablet 150 shows that the date that represents the EOQ alias 151 when application 110 is accessing data set 1 is Mar. 31, 2013. For example, data set 1 is the data that is associated with a first company. Tablet 160 shows that the date that represents the EOQ alias 151 when application 110 is accessing data set 2 is Mar. 15, 2013. Data set 2 is the data set that is associated with a second company.

The date that replaces the alias is determined from a context of the date entry. For example, the context may include a determination as to what application is requesting the date, what entity is associated with the date entry, and the like. For example, a user may be using application 110 on tablet 150 to perform tasks relating to a first company whose information is stored in Data Set 1. A user may be using application 110 on tablet 160 to perform tasks relating to a second company whose information is stored in Data Set 2. Each data set may define a same alias differently.

The date that is represented the alias may change using the same data set. For example, in a payroll date example (not shown), a next pay date “NPD” alias may change based on the employee. For example, some employees may be paid on one payroll schedule whereas other employees in the same company may be paid on a different schedule. When date manager 26 determines what date is represented by the alias “NPD”, the date may change determining on the employee related to the date field or date operation.

The data set that is used by date manager 26 to determine the date that is represented by the alias may be one or more data sets. Generally, the data set(s) that is used to determine the date is associated with a user or company relating to the date field. The aliases may be associated with more than one application. For example, the same alias may be used across different applications and may be interpreted the same or differently depending the on associated data.

In order to facilitate communication with date manager 26, one or more callback routines, may be implemented. Application 110 may be a variety of applications, such as business productivity applications, accounting applications, Customer Relationship Management (CRM) applications, entertainment applications, music applications, travel applications, video applications, and the like. According to an embodiment, application 110 is an Enterprise Management Software (EMS) software application. Generally, application 110 may be any application that is configured to receive date entries or date selections.

Application 110 may be configured to receive different types of input (e.g. speech input, touch input, keyboard input (e.g. a physical keyboard and/or Software Input Panel (SIP)) and/or other types of input. System 100 as illustrated comprises one or more touch screen input devices, such as tablet computing device 150 and tablet computing device 160, that detects when a touch input has been received (e.g. a finger touching or nearly touching the touch screen). Any type of touch screen may be utilized that detects a user's touch input. More details are provided below.

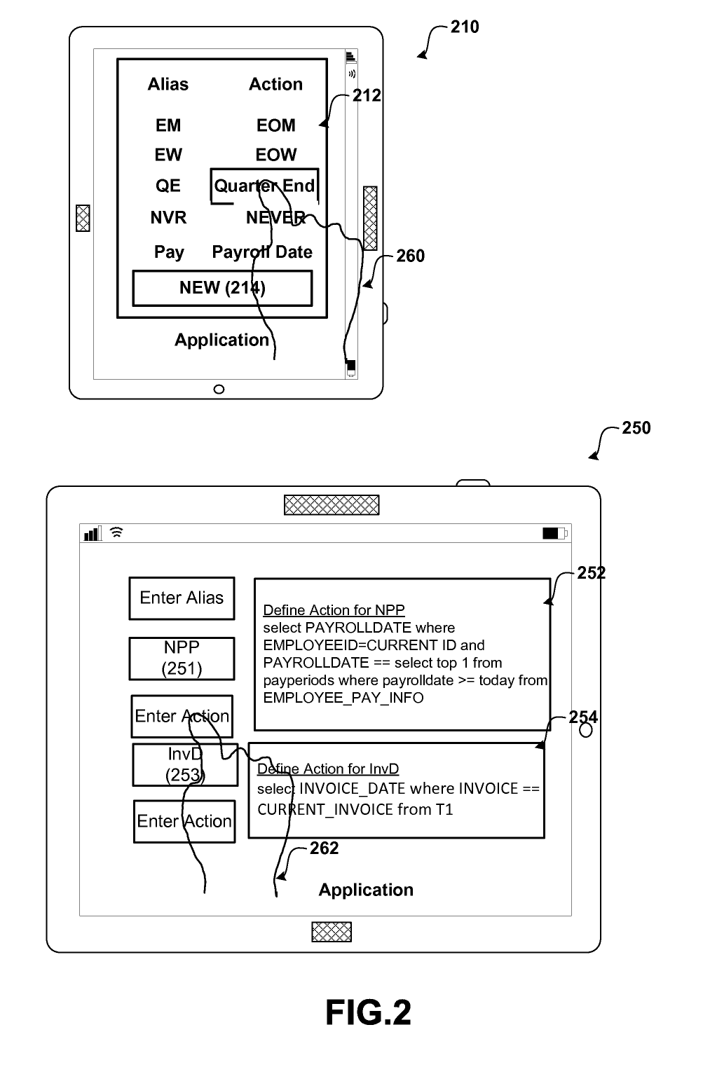

FIG. 2 shows displaying defined aliases and creating a new alias that represents a date.

Display 210 shows a list of aliases and defined actions. The list of aliases 212 may include aliases defined by a user as well as aliases defined by the application. An application may define a set of aliases that relate to the functionality of the application. For example, a financial application may define aliases for dates that are commonly entered by a user of the application (e.g. invoice date, payroll date, fiscal year end, fiscal quarter end, and the like). A real estate application may include aliases for items such as closing date, move-in date, inspection date, and the like.

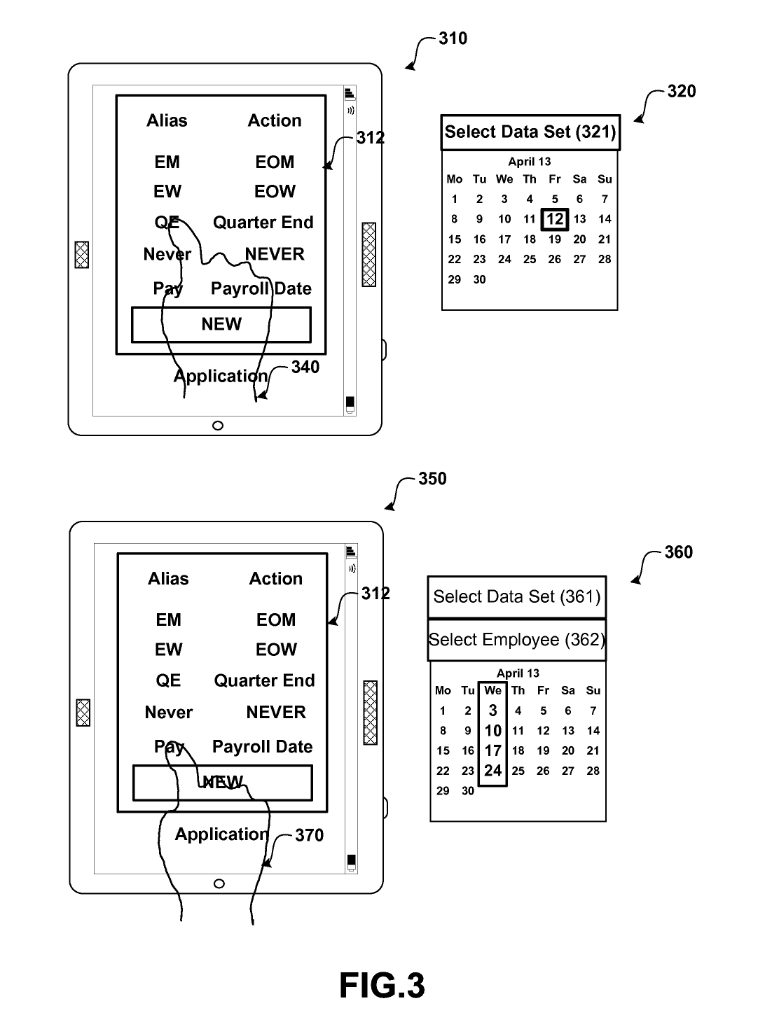

A user may select an alias to perform an operation. For example, a user 260 may select an action to edit the definition of the action that is associated with the alias. The user may also delete an alias, create a new alias, or see what date the alias represents when accessing a particular data set (e.g. See FIG. 3 and related discussion).

Display 250 shows creating new aliases and their definitions. For example, a user may select the “NEW” option 214 in display 210 to create a new alias definition. In the example shown in display 250, a user 262 is creating two new aliases including a Next Pay Period (“NPP”) alias 251 and an Invoice Date (“InvD”) alias 253. An alias may be associated with a simple action or a more complex action. For example, an alias with a simple association may be the alias “EOW” that represents the date at the end of the current week. Other example aliases with simple associations may include aliases such as: +10 to represent 10 days from the current date; +30 to represent 30 days from the current date; EOW to represent the end of the current week; EOM to represent the end of month; EOY to represent the end of the current year; NVR to represent “never”, TDY to represent “today”, and the like.

An expression editor may be used to create definitions for the action to perform when an alias is entered for a date. The expressions may include the use of other defined values within a data set to determine a value of the alias. The expressions may also include logic tests (e.g. if B>A then select C unless D<=E). In the current example, the action 252 that is defined for the NPP alias 251 is: “select PAYROLLDATE where EMPLOYEEID=CURRENT ID and PAYROLLDATE==select top 1 from payperiods where payrolldate>=today from EMPLOYEE_PAY_INFO.” The action 254 defined for the InvD alias 253 is “select INVOICE_DATE where INVOICE==CURRENT_INVOICE from T1.” Generally, any expression may be entered to determine the date that is associated with the alias.

FIG. 3 shows displaying a date in response to selecting an alias.

Display 310 shows a list 312 of aliases and defined actions. In display 310, a user 340 is selecting the QE alias to see the date that is represented by the alias when using a particular data set. For example, a user may be testing the defined action to help ensure that the date that replaces the alias is correct. In the current example, the QE date determined from a currently selected data set is April 12^{th} as displayed in calendar display 320. A user may change data sets used to determine the date for the QE alias by selecting the Select Data Set Option 321. For example, selecting a data set that is associated with a different company or user may change the date represented by the QE alias.

Display 350 shows a list 312 of aliases and defined actions. In display 350, a user 370 is selecting the Pay alias to see the date(s) in the currently displayed month that is selected with the alias. In the current example, the Pay dates determined from a selected data set are April 3^{rd}, 10^{th}, 17^{th}, and 24^{th} as displayed in calendar display 360. A user may change data sets used to determine the date for the Pay alias by selecting the Select Data Set Option 361. The user may also select a different employee to see the pay dates for that employee using the Select Employee 362 option.

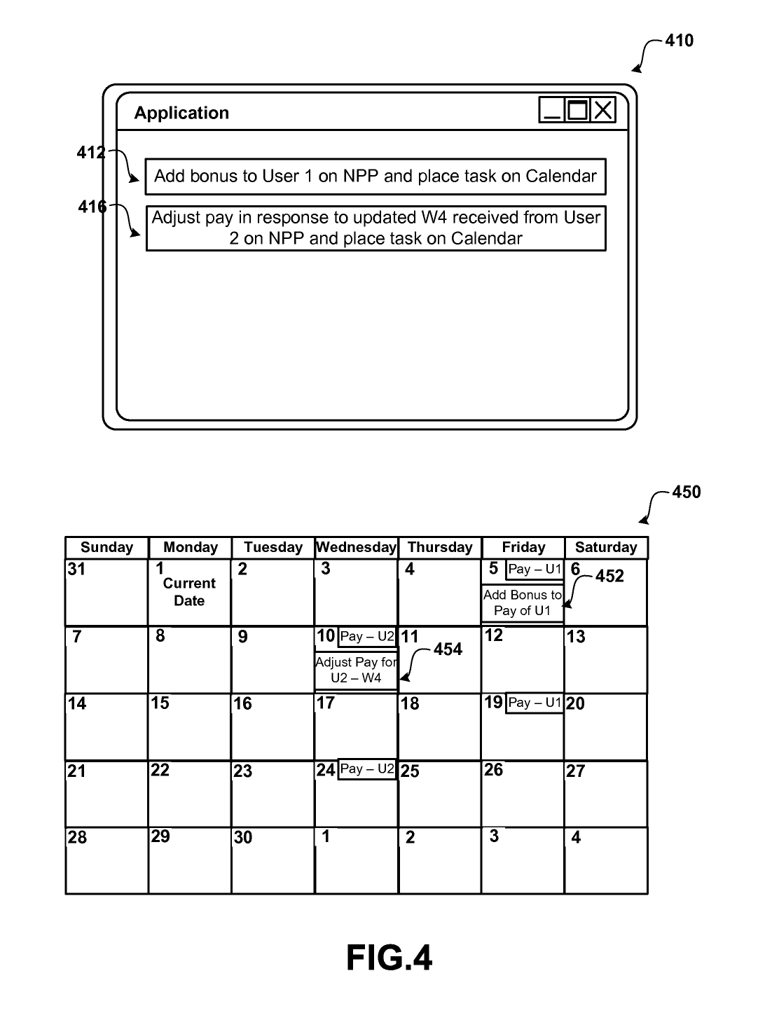

FIG. 4 shows using aliases in place of specific dates when specifying actions to perform.

Display 410 illustrates an application showing defined tasks to perform that include one or more aliases within the definition. Task 412 shows the use of a Next Pay Period “NPP” alias in a task to add a bonus for User 1 on the next pay date and to place the task on the calendar. Task 416 shows the use of the “NPP” alias in a task to adjust the pay of User 2 in response to a recently received W4 for User 2 and to place the task on the calendar.

Display 450 shows a calendar illustrating the payroll dates for User 1 and the payroll dates for User 2 in the month of April. For purposes of explanation, assume that the current date is April 1^{st}. Instead of the user that is configuring the tasks having to remember or look up the pay dates for User 1 and User 2, the user may enter the NPP alias in place of the date. When date that is represented by the NPP alias is determined using the associated data set, the pay date for User 1 is determined and the pay date for User 2 is determined Referring to the display 450 it can be seen that the next pay date for User 1 is April 5^{th} and the next pay date for User 2 is April 10^{th}. If the current date was April 6^{th} instead of April 1^{st}, the next pay date for User 1 would be April 19^{th} and the next pay date for User 2 would still be April 10^{th}. In the current example, task 412 and task 416 included an instruction to add the task to the calendar at the determined date. As can be seen on display 450, the calendar has been updated to include item 452 and item 454. As can be seen, an alias may be used in many different scenarios. For example, a user may specify an alias in the creation of a calendar appointment, a recurring appointment, and the like.

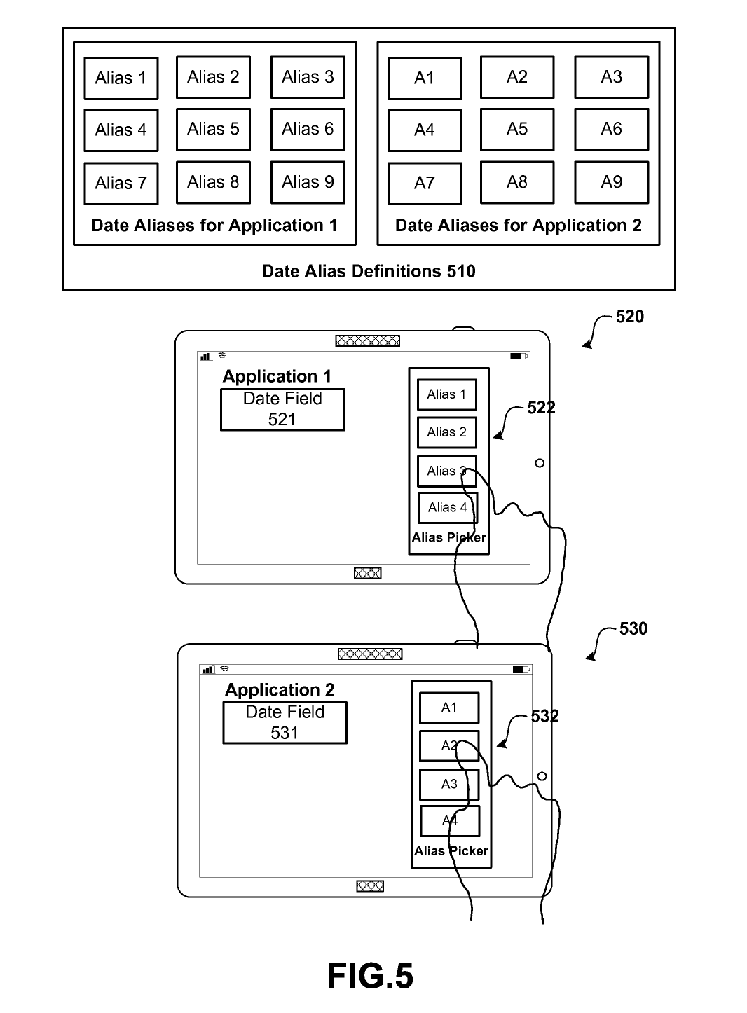

FIG. 5 shows selecting an alias to enter into a date field.

Date alias definitions 510 shows aliases that are defined for different applications. Aliases may be associated with a single application or multiple applications. For example, an alias may be defined and associated with a specific application or an alias may be defined to be associated with two or more different applications. An alias may be predefined and/or defined by a user. According to an embodiment, a user may edit predefined aliases to include different defined actions that are used to determine the actual date represented by the alias.

Display 520 shows a user selecting an alias to enter into date field 521 of Application 1 using alias picker 522. Other methods may be used to enter an alias into a date field. For example, speech input, text input, menu selections, and the like may be used to select or enter an alias.

Display 530 shows a user selecting an alias to enter into date field 531 of Application 2 using alias picker 532. As can be seen, alias picker 532 includes the aliases defined for Application 2.

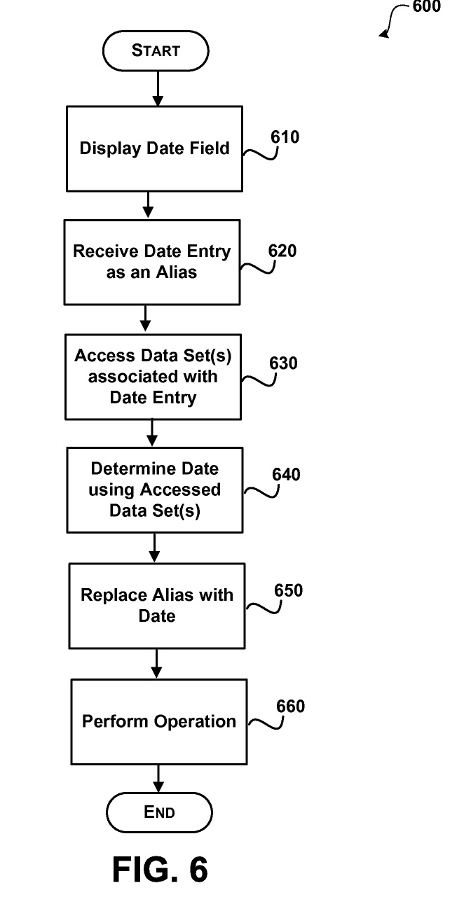

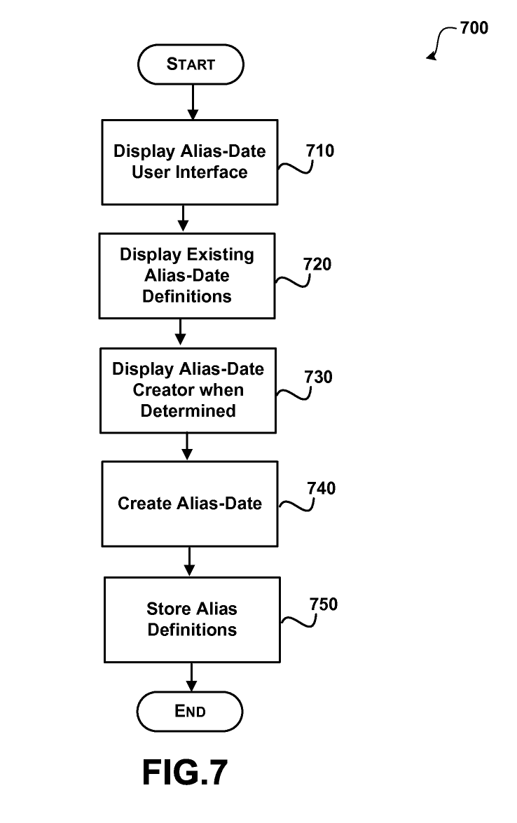

FIGS. 6 and 7 illustrates a process for using aliases for data entry. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the order of the operations may change, be performed in parallel, depending on the implementation.

FIG. 6 illustrates a process 600 for using an alias that represents a date in a date field.

After a start operation, the process moves to operation 610, where a date field is displayed. The date field may be displayed in many different ways. For example, a date field may be: a GUI element displayed in a form, a pop-up window, a cell of a spreadsheet, a table element, a value within a database, and the like. Generally, a date field is any field that expects a date as an entry.

Flowing to operation 620, an alias is received for the date entry. Instead of entering or selecting the actual date within the date field, an alias that represents the date is received. The actual date that the alias represents may change depending on what data set is used to determine the date or what user is associated with the date entry.

Transitioning to operation 630, the data set that is used to determine the date that is represented by the alias is accessed. Generally, the data set that is selected is the data set that is currently being interacted with and relates to the date entry field. For example, the data set may be a data set that is associated with a particular company or user. The data set that is accessed is used to determine the date that the alias represents.

Flowing to operation 640, the date that represents the alias is determined using the accessed data set(s). The data set defines the value for the date. For example, a first company's data define the fiscal year end as December 31^{st} whereas a second company's data set defines the fiscal year end as June 30^{th}. An alias (e.g. “FYE”) that represents the fiscal year end is interpreted as December 31^{st} when using the first company's data set and March 31^{st} when using the second companies data set. The association between the alias and the date may be determined using different methods. For example, a defined relationship may be defined between the alias and the date.

Transitioning to operation 650, the alias in the date field is replaced with the determined date.

Flowing to operation 660, the operation that uses the date is performed. Many different operations may be performed.

The process then flows to an end operation and returns to processing other actions.

FIG. 7 illustrates a process 700 for configuring a definition of an alias that represents a date.

After a start operation, the process moves to operation 710, where an alias-date user interface is displayed. The alias-date user interface may be as simple as displaying a text file or displaying a graphical user interface including different elements for configuring the alias-date relationship.

Flowing to operation 720, any existing alias-date definitions may be displayed. For example, previously created aliases may be displayed in a list within the alias-date user interface. According to an embodiment, when an alias definition in the list is selected, more information relating to the alias is displayed. For example, the definition is displayed that allows a user to edit the definition. A user may also remove one or more of the defined aliases or select an option to create a new alias-date definition.

Transitioning to operation 730, the alias-date creator is displayed when determined. For example, a user may select an option to create a new alias definition.

Flowing to operation 740, an alias is created to represent the date. According to an embodiment, an alias is entered into the alias-date creator along with an action that is taken when the alias is received. The alias is one or more characters that identify the action. For example, an alias may be a common term that is used to represent some date (e.g. YE for year end, EM for EOM, Pay for payroll date, and the like.) The action may be a simple action or a more complex action. For example, the action may be set using an expression editor that allows a user to specify different conditions when defining the action to associate with the alias. For example, one defined action for an InvoiceDate (e.g. “InvD”) may be defined as “Select INVOICE_DATE where INVOICE==CURRENT_INVOICE from T1.” Another more complicated defined action example is for a next pay period (NPP) alias that may be defined as: select PAYROLLDATE where EMPLOYEEID=CURRENT ID and PAYROLLDATE==select top 1 from payperiods where payrolldate>=today from EMPLOYEE_PAY_INFO.

Transitioning to operation 750, the alias definitions are stored. The aliases may be associated with one or more data sets. For example, the aliases may be set per user, per company, per application, and the like.

The process then flows to an end operation and returns to processing other actions.

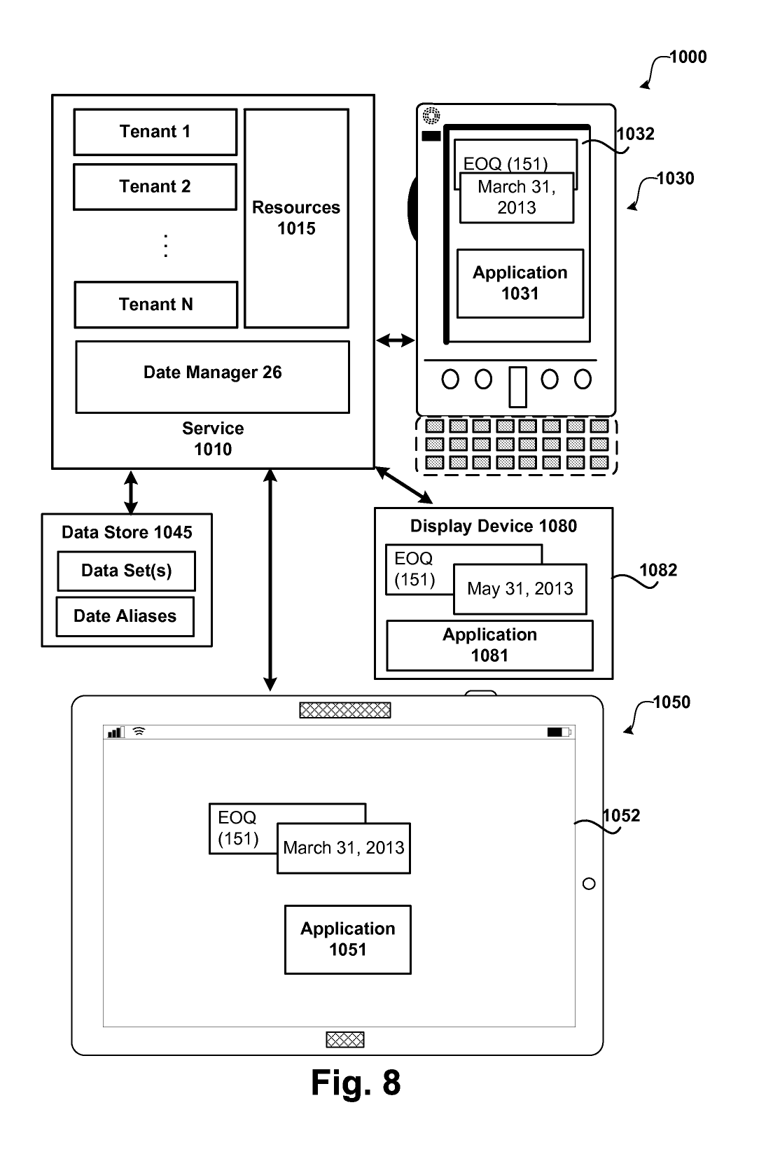

FIG. 8 illustrates an exemplary online system for using aliases for date entry. As illustrated, system 1000 includes service 1010, data store 1045, touch screen input device 1050 (e.g. a slate), smart phone 1030 and display device 1080.

As illustrated, service 1010 is a cloud based and/or enterprise based service that may be configured to provide services, such as productivity services (e.g. CRM, EAS, spreadsheets, documents, presentations, charts, messages, and the like)). The service may be interacted with using different types of input/output. For example, a user may use speech input, touch input, hardware based input, and the like. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030, touch screen input device 1050, and device 1080 each include an application (1031, 1051, 1081) that are configured to receive aliases in place of actual dates.

As illustrated, touch screen input device 1050, smart phone 1030, and display device 1080 shows exemplary displays 1052/1032/1082 showing the use of an application and an alias. Data may be stored on a device (e.g. smart phone 1030, slate 1050 and/or at some other location (e.g. network data store 1045). Data store 1045, or some other store, may be used to store data sets, date alias definitions, as well as other data. The applications used by the devices may be client based applications, server based applications, cloud based applications and/or some combination. According to an embodiment, display device 1080 is a device such as a MICROSOFT XBOX coupled to a display.

Date manager 26 is configured to perform operations relating to using aliases for date entry as described herein. While manager 26 is shown within service 1010, the functionality of the manager may be included in other locations (e.g. on smart phone 1030 and/or slate device 1050 and/or device 1080).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

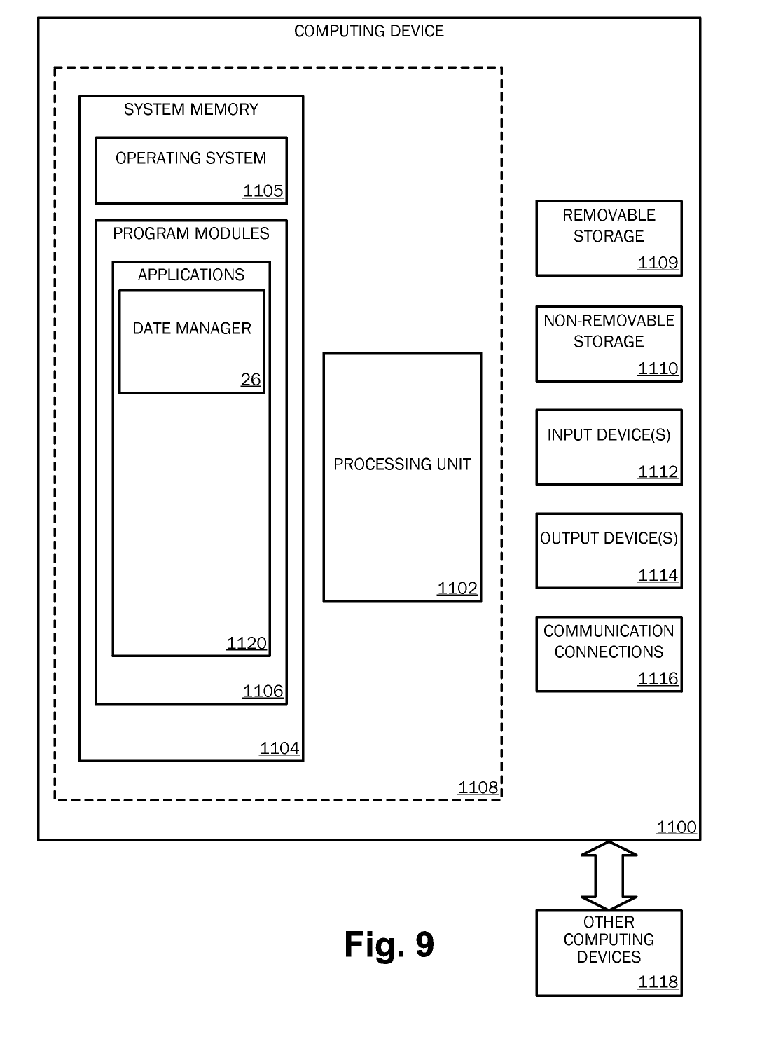

FIGS. 9-11 and the associated descriptions provide a discussion of a variety of operating environments in which embodiments of the invention may be practiced. However, the devices and systems illustrated and discussed with respect to FIGS. 9-11 are for purposes of example and illustration and are not limiting of a vast number of computing device configurations that may be utilized for practicing embodiments of the invention, described herein.

FIG. 9 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the date manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 9 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 9 by a removable storage device 1109 and a non-removable storage device 1110.

As stated above, a number of program modules and data files may be stored in the system memory 1104. While executing on the processing unit 1102, the program modules 1106 (e.g., the date manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the date manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

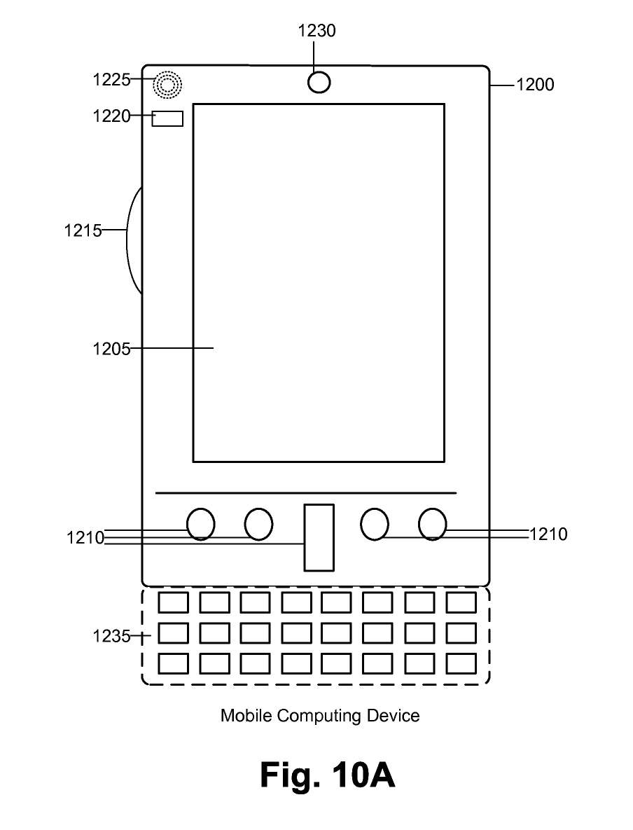

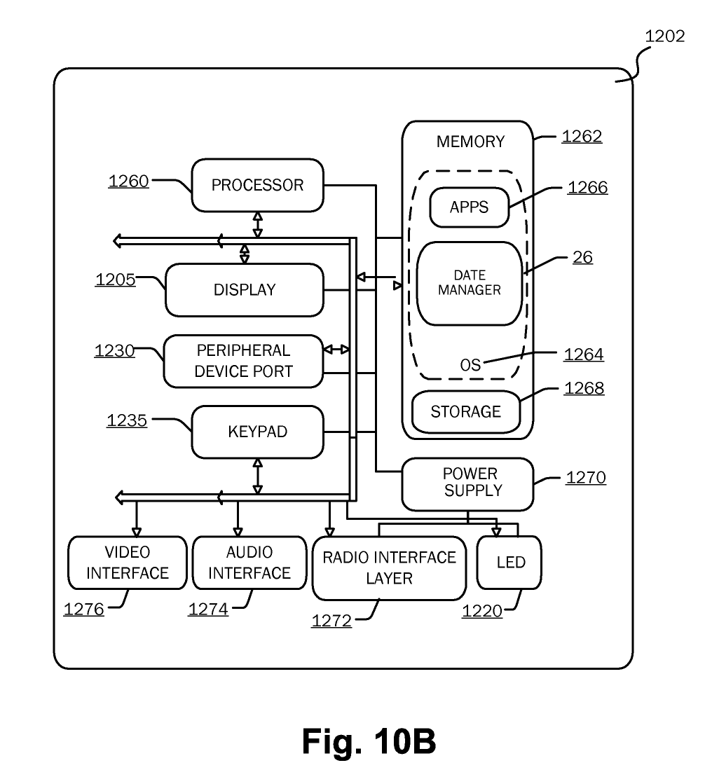

FIGS. 10A and 10B illustrate a mobile computing device 1200, for example, a mobile telephone, a smart phone, a tablet personal computer, a laptop computer, and the like, with which embodiments of the invention may be practiced. With reference to FIG. 10A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one embodiment of a mobile computing device. That is, the mobile computing device 1200 can incorporate a system 1202 (i.e., an architecture) to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the date manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 10B by the non-volatile storage area 1268. Mobile computing device 1200 may also include peripheral device port 1230.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

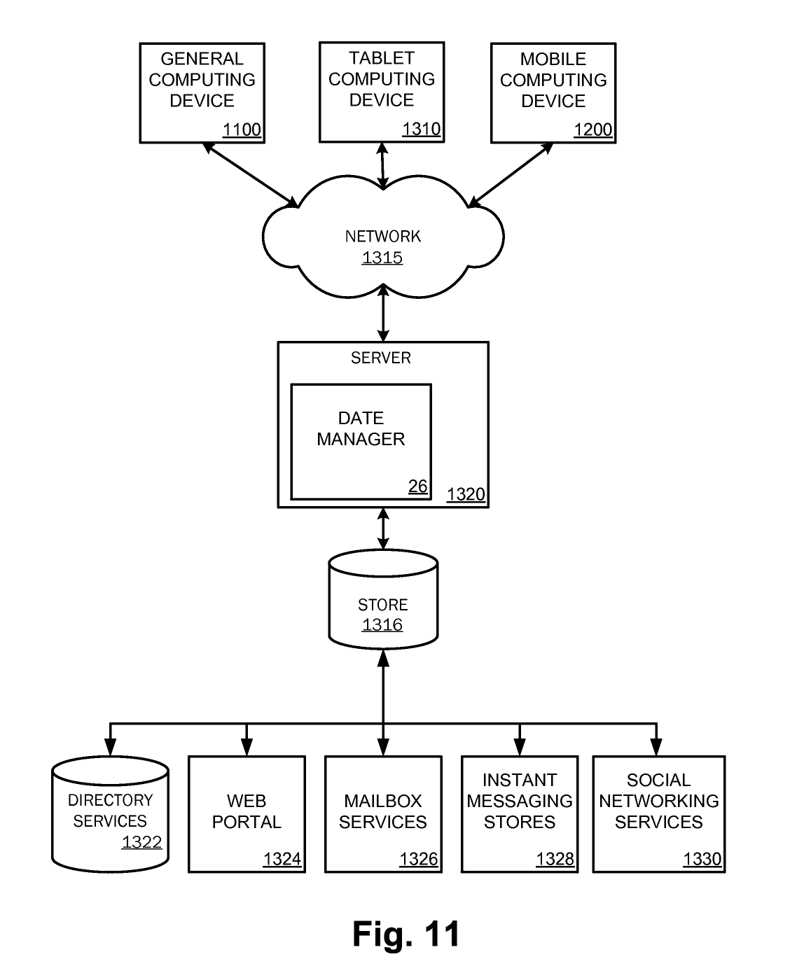

FIG. 11 illustrates an embodiment of an architecture of an exemplary system, as described above. Content developed, interacted with, or edited in association with the date manager 26 may be stored in different communication channels or other storage types. For example, various documents may be stored using a directory service 1322, a web portal 1324, a mailbox service 1326, an instant messaging store 1328, or a social networking site 1330. The date manager 26 may use any of these types of systems or the like for enabling data utilization, as described herein. A server 1320 may provide the date manager 26 to clients. As one example, the server 1320 may be a web server providing the date manager 26 over the web. The server 1320 may provide the date manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for using aliases for date entry, comprising:
receiving a date entry in an application that is in a form of an alias;
determining a date that is represented by the alias using a data set that is associated with a user; and
replacing the alias with the date determined using the data set.

2. The method of claim 1, wherein determining the date that is represented by the alias comprises locating a definition of the alias within the data set.

3. The method of claim 1, wherein determining the date that is represented by the alias comprises accessing a financial data set that includes a definition of the alias used to determine the date.

4. The method of claim 1, wherein determining the date that is represented by the alias comprises determining an entity that is associated with the date entry and determining from the data set the definition of the alias based on the entity.

5. The method of claim 1, further comprising displaying an alias-date user interface that includes a new option that is used in creating a new definition of an alias that represents a date.

6. The method of claim 5, further comprising displaying an expression editor used in creating a definition of the alias.

7. The method of claim 1, wherein the date that is determined is different depending on a selected data set.

8. The method of claim 1, further comprising including predefined aliases comprising: an EOW token to represent an end of week date; an EOM token to represent an end of month date; and an EOY token to represent an end of year date.

9. The method of claim 1, wherein the data set is associated with a customer relationship management software application.

10. A computer-readable medium storing computer-executable instructions for using aliases for date entry, comprising:
receiving a date entry in an application that is in a form of an alias;
determining a date that is represented by the alias using a data set that is associated with a context of the date entry; and
replacing the alias with the date determined using the data set.

11. The computer-readable medium of claim 10, wherein determining the date that is represented by the alias comprises locating a definition of the alias within the data set.

12. The computer-readable medium of claim 10, wherein determining the date that is represented by the alias comprises determining an entity that is associated with the date entry and determining from the data set the definition of the alias based on the entity.

13. The computer-readable medium of claim 10, further comprising displaying an alias-date user interface that includes options for editing aliases.

14. The computer-readable medium of claim 10, further comprising displaying an expression editor used to define a definition of the alias.

15. The computer-readable medium of claim 10, wherein the date that is determined is different depending on a selected data set.

16. The computer-readable medium of claim 10, wherein the data set is associated with a customer relationship management software application.

17. A system for using aliases for date entry, comprising:
a processor and memory;
an operating environment executing using the processor; and
a date manager that is configured to perform actions comprising:
receiving a date entry in an application that is in a form of an alias;
determining a date that is represented by the alias using a data set that is associated with a context of the date entry; wherein the date represented by the alias is determined using definitions in a selected data set; and
replacing the alias with the date determined using the data set.

18. The system of claim 17, wherein determining the date that is represented by the alias comprises determining an entity that is associated with the date entry and determining from the data set the definition of the alias based on the entity.

19. The system of claim 17, further comprising displaying an alias-date user interface that includes options for editing aliases.

20. The system of claim 17, wherein the data set is associated with a customer relationship management software application.
